(19) United States
(12) Patent Application Publication
(10) Pub. No.: US 2011/0204697 A1
(43) Pub. Date: Aug. 25, 2011

(54) Dump Box System for a Conventional Pickup Truck Bed

(76) Inventor: Ronald E. Paxton, La Mesa, CA (US)

(21) Appl. No.: 12/712,555

(22) Filed: Feb. 25, 2010

(51) Int. Cl. B60P 1/30

(52) U.S. Cl. 298/14

(57) ABSTRACT

The dump box system includes a dump box that rolls along the length of the pickup truck bed. The movement of the dump box is controlled by a hoist system attached to the truck bed. The hoist system has a pair of reels in spaced relation along a drive shaft. The drive shaft is turned by a crank-operated winch unit so that straps coiled on the reels are reeled in or paid out. The dump box can be moved from a position wherein it is completely encased within the truck bed to a position where it is tilted and hanging out through the rear opening of the truck bed. The design of the dump box system allows the user to quickly unload large quantities of debris and other materials from the truck without the need for resort to shovels or rakes.

### BACKGROUND OF THE INVENTION

1. Field of the Invention

This invention relates generally to cargo transportation apparatus for vehicles and, more specifically, to a Dump Box System for a Conventional Pickup Truck Bed.

2. Description of Related Art

Pickup trucks are possibly the most versatile personal vehicles on the road today. Of course, there are many professions to which the pickup is indispensable, such as the construction industry. Over the years, due to the superior flexibility and utility, however, to pickup trucks have become popular as a means of daily transportation. These vehicles are even produced in versions that would rival many luxury cars.

What has always been missing from the pickup truck, however, is the ability to easily and quickly unload its contents, such as dirt and demolition material, when necessary. The problem with using a pickup truck for such applications is not related to its hauling capacity. On the contrary, the conventional pickup truck has the load capacity and size to be used in this type of service. The problem is one of convenience and ease, and therefore speed, of use.

Since the conventional pickup truck has a fixed bed (i.e. one that does not tilt and dump), the user is relegated to shoveling, raking or sweeping out the bed of loads of granular material. While this does not necessarily defeat the pickup truck from being used in these applications, it certainly prevents them from being viable in any kind of regular role for this purpose. The problem is that, historically, converting a conventional pickup truck so that it has a dump-able bed volume has been prohibitively expensive. Furthermore, these aftermarket conversions generally include electromechanical and/or hydraulic systems that tend to have a much shorter service life (and/or require more maintenance and repair) than the rest of the pickup truck. What is needed, then, is a cost-effective after-market system that can be installed on a conventional pickup truck that will approximate the utility of a tilt-bed truck, without the associated installation or maintenance costs.

### SUMMARY OF THE INVENTION

In light of the aforementioned problems associated with the prior devices and systems, it is an object of the present invention to provide a Dump Box System for a Conventional Pickup Truck Bed. The dump box system should include a dump box that rolls along the length of the pickup truck bed. The movement of the dump box should be controlled by a hoist system attached to the truck bed. The hoist system may have a pair of reels in spaced relation along a drive shaft. The drive shaft might be turned by a crank-operated winch unit so that straps coiled on the reels are reeled in or paid out. The dump box should be moved from a position wherein it is completely encased within the truck bed to a position where it is tilted and hanging out through the rear opening of the truck bed. The design of the dump box system should allow the user to quickly unload large quantities of debris and other materials from the truck without the need for resort to shovels or rakes.

### BRIEF DESCRIPTION OF THE DRAWINGS

The objects and features of the present invention, which are believed to be novel, are set forth with particularity in the appended claims. The present invention, both as to its organization and manner of operation, together with further objects and advantages, may best be understood by reference to the following description, taken in connection with the accompanying drawings, of which:

FIG. 1 is a partial side view of a conventional pickup truck having a preferred embodiment of the dump box system of the present invention installed therein;

FIG. 2 is a partial side view of the truck of FIG. 1 with the dump box in the partially deployed position;

FIG. 3 is a partial side view of the truck of FIGS. 1 and 2 with the dump box deployed until it is touching the ground;

FIG. 4 is a rear perspective view of the truck of FIGS. 1-3 with the dump box secured for over-the-road transit;

FIG. 5 is a rear perspective view of the truck of FIG. 4 with the box gate open;

FIG. 6 is a rear view of the truck of FIGS. 1-5 with the dump box partially deployed;

FIG. 7 is a partial side perspective view of the hoist system of the dump box system of FIGS. 1-6;

FIG. 8 is another partial side perspective view of the hoist system of the dump box system of FIGS. 1-8;

FIG. 9 is yet another partial side perspective view of the hoist system of the dump box system of FIGS. 1-8;

FIG. 10 is a view of the underside of the dump box from inside of the truck bed of the truck of FIGS. 1-9; and

FIG. 11 is a partial perspective view of the wheel racks and forward end of the dump box of the truck of FIGS. 1-10.

### DETAILED DESCRIPTION OF THE PREFERRED EMBODIMENTS

The following description is provided to enable any person skilled in the art to make and use the invention and sets forth the best modes contemplated by the inventor of carrying out his invention. Various modifications, however, will remain readily apparent to those skilled in the art, since the generic principles of the present invention have been defined herein specifically to provide a Dump Box System for a Conventional Pickup Truck Bed.

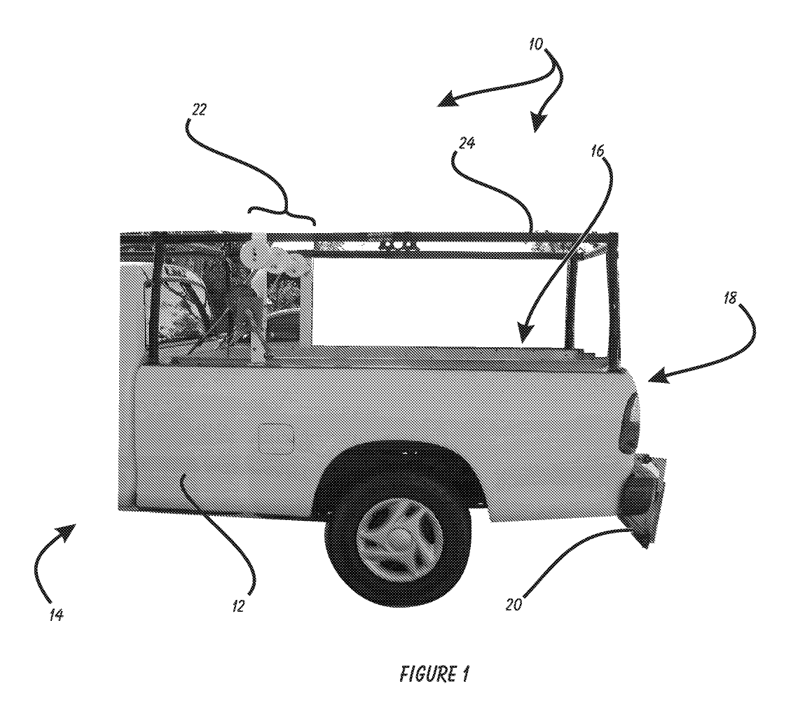

The present invention can best be understood by initial consideration of FIG. 1. FIG. 1 is a partial side view of a conventional pickup truck 14 having a preferred embodiment of the dump box system 10 of the present invention installed therein. The Dump Box System 10 of the present invention is designed to be installed in the bed 12 of a conventional pickup truck 14. In this version, the pickup truck 14 has a utility rack assembly 24 attached to the bed. As will be discussed later on in this writing, the rack assembly 24 can prove to be useful, but it is not necessary in order for the Dump Box System 10 to be usable with a pickup truck 14. However, if a rack assembly 24 is already installed to the bed 12, it will certainly not interfere with the installation of the Dump Box System 10.

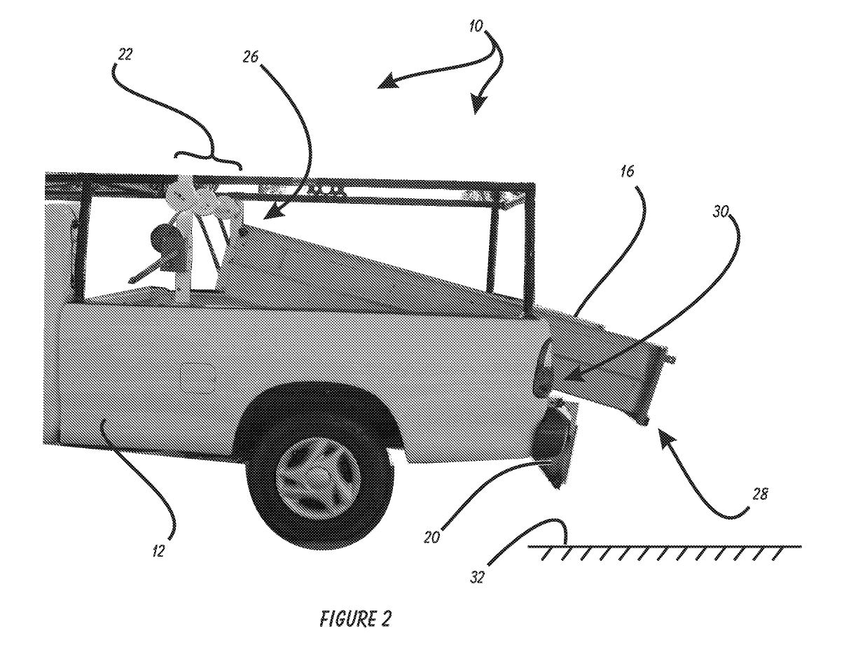

The System 10 has two main components: the dump box 16 and the hoist system 22. The dump box 16 is designed to roll in and out of the rear opening 18 of the bed 12. From this view it can be seen that the box 16 has a gate 20 that can be opened and closed in replacement of the standard tailgate provided with the pickup truck 14 when it was originally acquired. Now turning to FIG. 2 we can begin to see the progression of operational positions through which the Dump Box System 10 of the present invention moves.

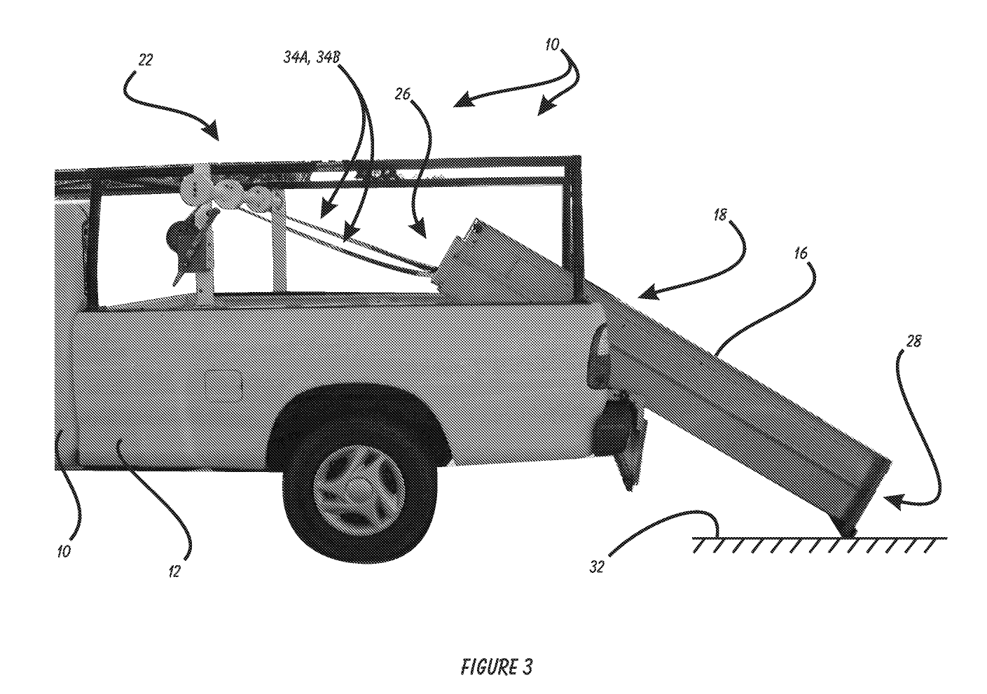

FIG. 2 is a partial side view of the truck of FIG. 1 with the dump box 16 in the partially deployed position. In this position the dump box 16 has been lifted by the hoist system 22, which attaches at the forward end 26 of the dump box 16. As can be seen, the box 16 is cantilevering on the edge 30 of the truck bed 12. The rear end 28 of the dump box is, as a result, becoming closer to the ground 32. It is pointed out here that the box gate 20 is actually attached to an associated structure related to the Dump Box System 10. In any event, the box gate 20 remains attached to the bed 12 rather than to the dump box 16. As will become clearer in later drawing figures, the gate 20 serves to close the opening at the rear end 28 of the box 16. If we now turn to FIG. 3, we can see the next phase in the motion of the system 10.

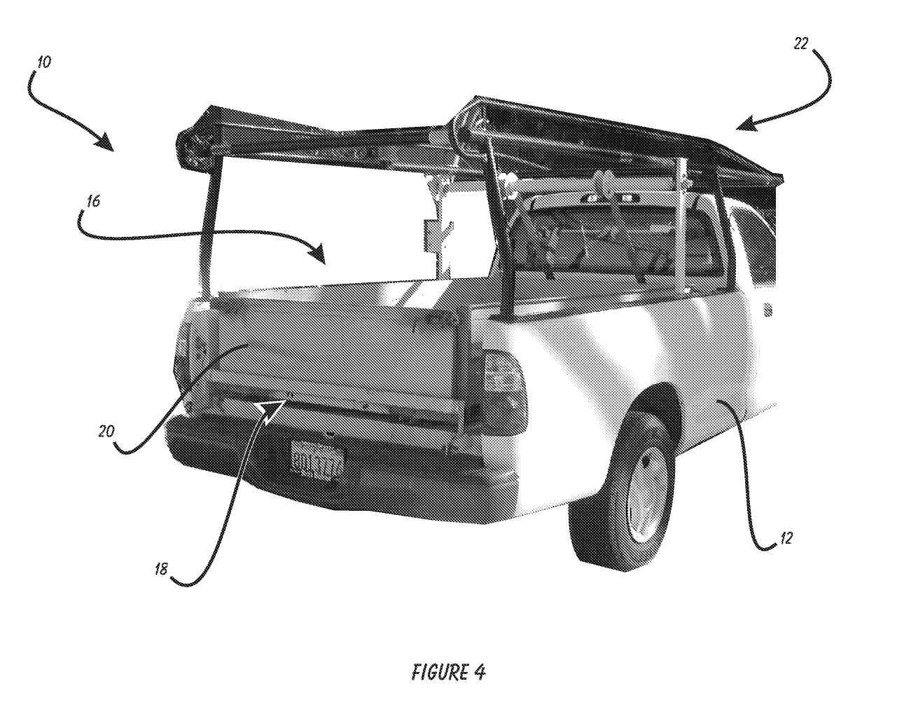

FIG. 3 is a partial side view of the truck 14 of FIGS. 1 and 2 with the dump box 16 deployed until it is touching the ground 32. As shown here, the hoist system 22 has been further actuated so that the straps 34A and 34B have been allowed to pay out a substantial amount. As a result, more than half of the length of the dump box 16 is protruding out from the bed rear opening 18. In fact, in this step, the rear end of the box 28 has actually reached the ground 32. It is noted that the straps 34A and 34B are attached to the forward bottom edge of the forward end 26 of the dump box 16. In most cases, however, the user will place the box 16 in a position somewhere between that depicted in FIGS. 2 and 3 (i.e. not touching the ground) so that the contents of the box 16 will easily slide out through the open rear end 28. If the user then drives the vehicle 14 forward and quickly stops, the box will rock forwards and then backwards (in a sort of a whipping motion) so that the remainder of the materials will slide out through the rear end 28 until the box 16 is empty. At this point the hoist system 22 can be cranked in so that the straps 34A and 34B pull the box 16 back into the bed 12 until it is in the position as depicted previous in FIG. 1. FIG. 4 provides an additional view of the system 10.

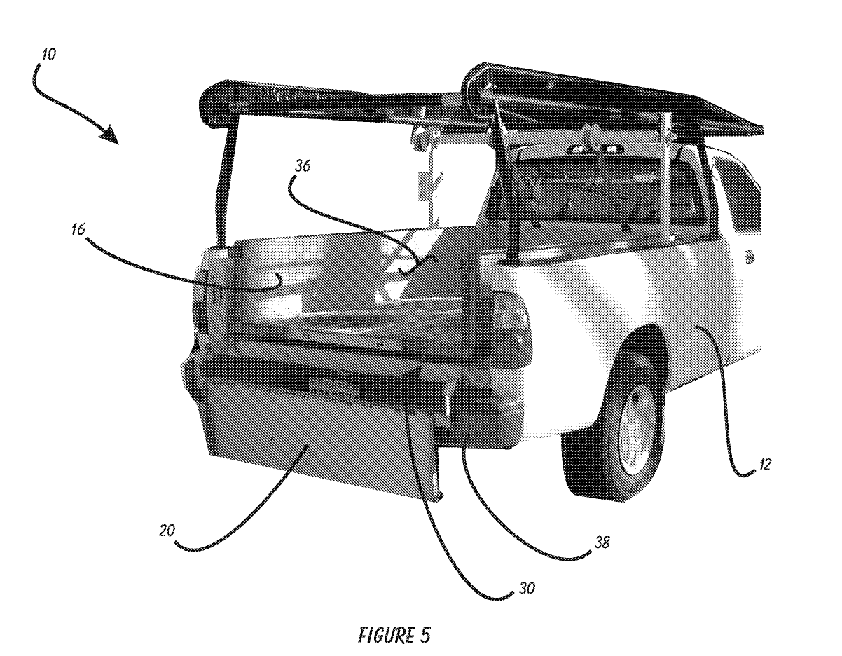

FIG. 4 is a rear perspective view of the truck 14 of FIGS. 1-3, with the dump box 16 secured for over-the-road transit. As shown here, the bed rear opening 18 is filled by the box 16, which is in fact enclosed by the box gate 20. In such a configuration, the user is free to drive the vehicle 14 and use it as if it were a normal pickup truck. FIG. 5 shows the same vehicle wherein the box gate 20 is open.

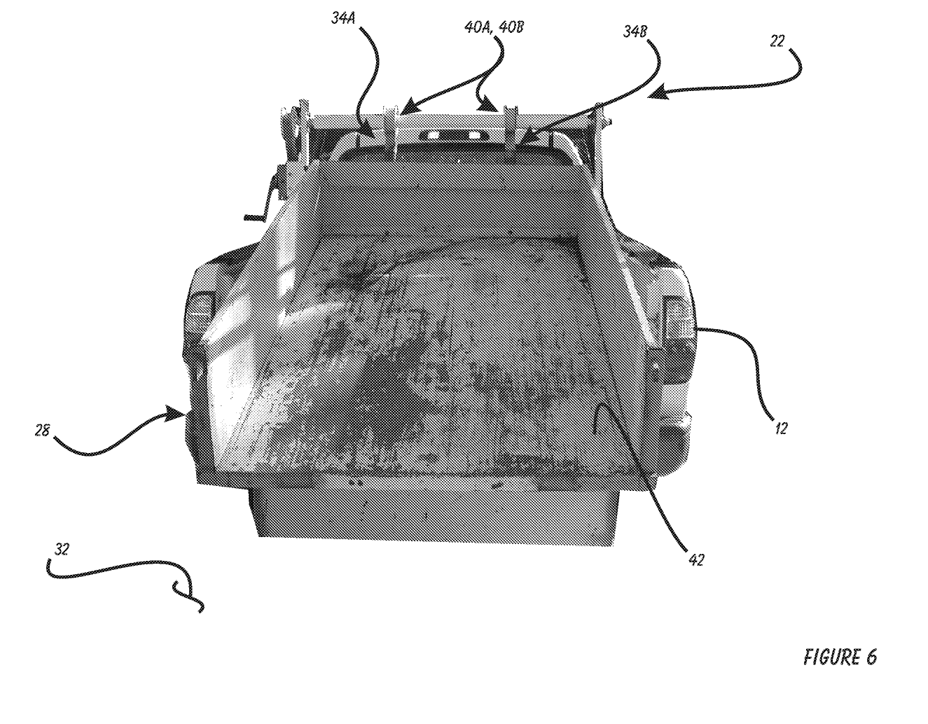

FIG. 5 is a rear perspective view of the truck of FIG. 4 with the box gate 20 open. In this view, it can be seen that the box gate 20 opens in such a way that it does not strike the bumper 38. However, unlike the conventional tailgate, it folds completely out of the way in a vertical position. This allows the dump box 16 to be hoisted straight out through the back of the bed 12 without any interference from the conventional tailgate. The interior volume 36 of the box is only slightly smaller than the original interior volume of the bed 12. However, as shown here, the sides of the box 16 are actually higher than the conventional bed 12. FIG. 6 shows yet another view.

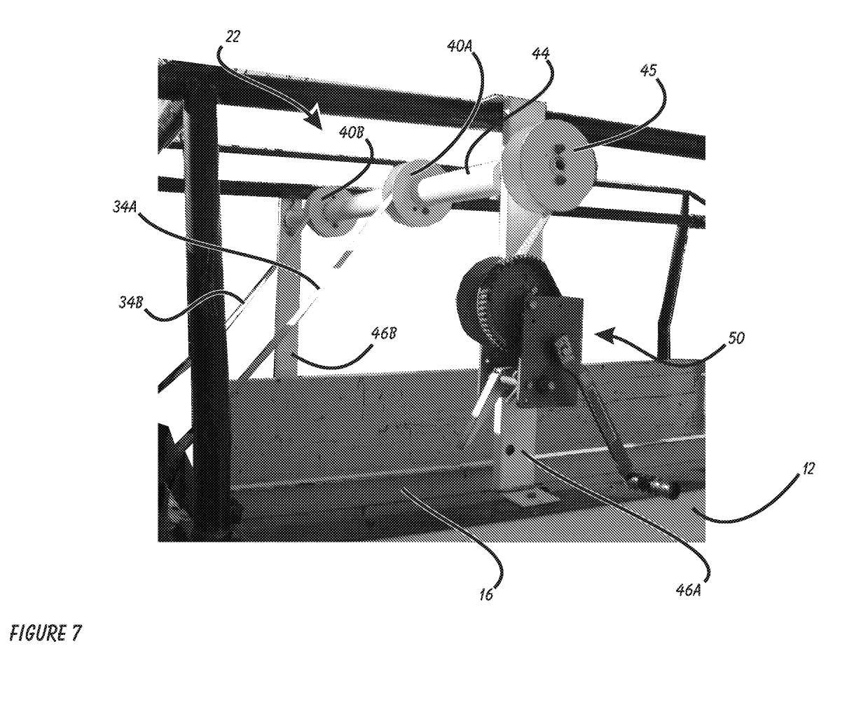

FIG. 6 is a rear view of the truck of FIGS. 1-5 with the dump box partially deployed. In this view the box 16 has been partially hoisted and has begun its extension out of the back of the bed 12. The first strap 34A and second strap 34B have been partially reeled in onto their associated reels 40A and 40B of the hoist system 22. It is by reeling these straps 34A and 34B in that the box 16 is caused to move from the position one shown in FIG. 1 and position two shown in FIG. 2. The straps 34A and 34B are paid out from the reels 40A and 40B. The result will be that the box rear end 28 will extend outwardly. At such time the load will begin to discharge its contents of its own weight. However, it should be understood that placing the box 16 in the position shown here may be sufficient to empty the box of the materials stored therein. Having fully discussed the overall functionality of the system of the present invention, we will now focus on the elements comprising the hoist system by turning to FIG. 7.

FIG. 7 is a partial side perspective view of the hoist system of the dump box system of FIGS. 1-6. The hoist system 22 comprises a first support post 46A and a second support post 4613 extending upwardly from the left and right sides of the bed 12. As shown here, the upper end of each support post 46A and 46B attaches to the upper rack rails 48A and 48B of the rack assembly 24. As discussed previously, this is not a critical feature, however it is important that there be bracing to prevent the support posts 46A and 46B from moving frontwards or backwards while taking on a load created by the hoist system 22. As such, the user may find that having the rack assembly 24 will be an important feature for his vehicle, although since many trucks do not have lumber racks installed on them.

For the stability of the hoist system, there are two required support post connections for each post. Support posts are first connected to the truck bed as an integral part of the wheel rack system. The second connection is made with a bracket connecting the support post to the top edge of the side panel of the truck.

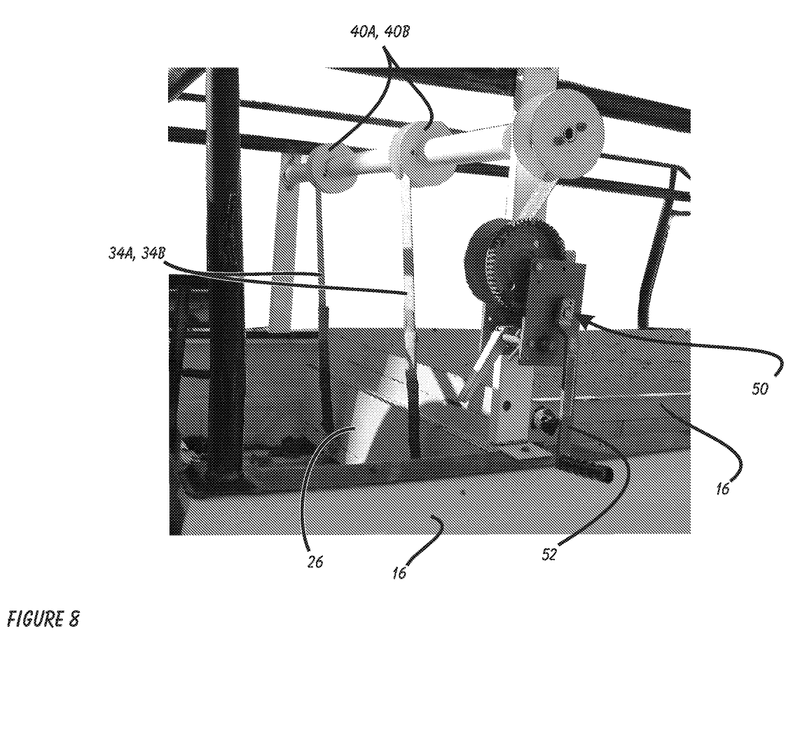

The hoist system 22 further has a drive shaft 44 along which the first and second reels 40A and 40B are located. As shown, the straps 34A and 34B can be reeled or paid out from their respective reels 40A and 408. Similarly, at one end of the drive shaft 44, a drive reel 45 is provided to generate the driving force to cause the drive shaft 44 to rotate and thereby reel in or pay out the straps 34A and 34B. The drive reel 45 is driven by drive strap 34C, which is driven by a crank-operated winch unit 50. The winch unit 50 is reversible and latchable so that it can be cranked in or paid out using the crank handle 52. We mention here that FIG. 7 depicts the box 16 in its stowed position. If we turn to FIG. 8, we can see the box in a partially paid out position.

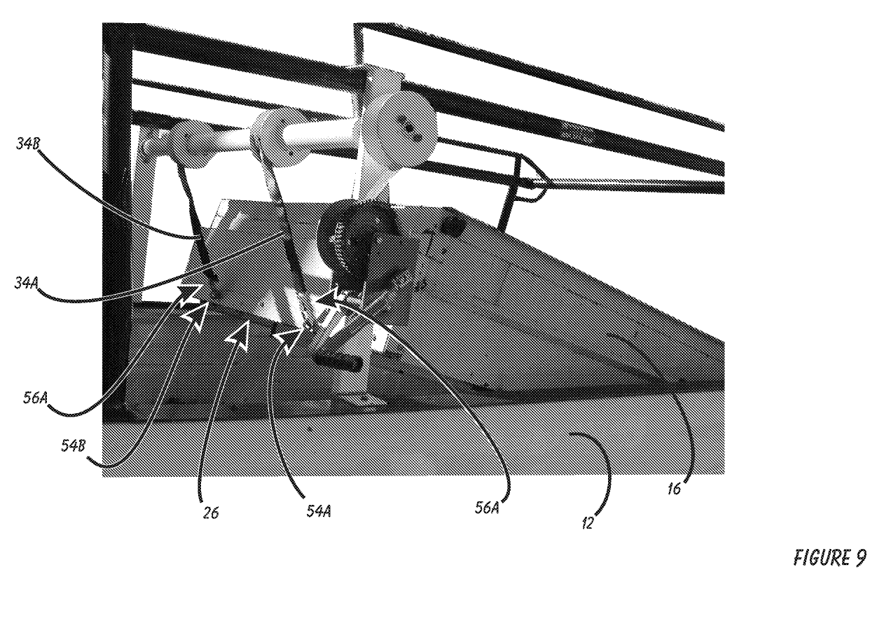

FIG. 8 is another partial side perspective view of the hoist system of the dump box system of FIGS. 1-8. As shown here, the box forward end 26 has been driven backward so that it no longer is next to the front of the bed 16. The straps 34A and 34B have been reeled in around reels 40A and 40B such that they are essentially vertical. This has caused the box 16 to slide backwardly and begin to slightly tilt. As discussed previously, this position was achieved by operation of the crank handle 52 to drive the winch unit 50 such that the reels 40A and 40B reel in the straps 34A and 34B. If continued cranking is performed, the position shown in FIG. 9 will be achieved.

FIG. 9 is yet another partial side perspective view of the hoist system of the dump box system of FIGS. 1-8. In this position the straps 34A and 34B have continued to be reeled in until the box forward end 26 has actually been lifted off the bottom of the bed 12. The first strap 34A terminates at its distal end in a first clip 56A. First clip 56A releasably attaches to a first loop 34A, which extends from the lower front end of the box 16. Similarly, the second strap 3433 is provided with a second clip 56B to releasably engage the second loop 54B. The clips 56A and 56B are releasable so that the user at their discretion can unclip them and actually remove the box 16 from the bed 12. Since we've now reviewed the features of the box and the operation of the box and the feature of the hoist, it only remains to discuss the structure that resides below the box.

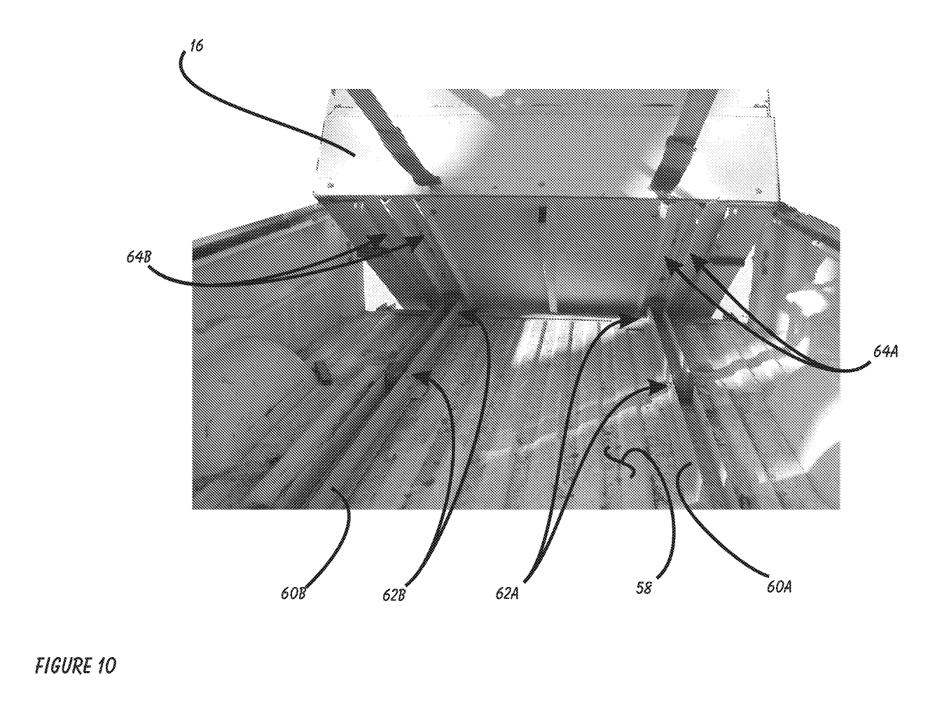

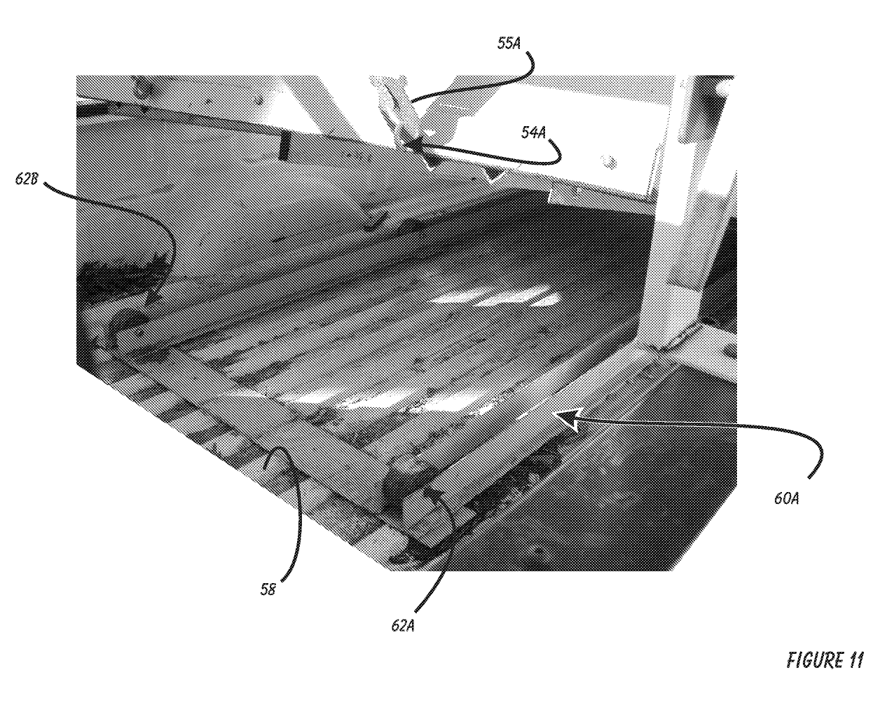

FIG. 10 is a view of the underside of the dump box from inside of the truck bed of the truck of FIGS. 1-9. The system 10 is provided with first and second wheel racks 60A and 60B that are each attached in space relation to the bottom of the bed 12. The first wheel rack 60A is provided with a series of first wheels 62A while the second wheel rack 60B is provided with a series of second wheels 6213 along its length. The wheel rack 60A and 60B are attached to the bottom of the bed 58. The dump box 16 is shown here in the tilted condition so that the first rail set 64A and second rail set 64B can be seen. These rails are configured to straddle the wheels 62A and 62B so that the dump box 16 will remain centered side to side within the truck bed 12. The bottom of the dump box 16 will actually rest on top of the wheel 62A and 62B which is the reason why the dump box 16 easily rolls in and out of the truck bed 12. It is also pointed out that at the open end of the truck bed 12 are a pair of wheels 62A and 62B which support the bottom of the dump box 16 while preventing the box 16 from rubbing against the edge of the truck bed 12 or the tailgate or the bumper (not shown). FIG. 11 shows an additional view of the structure.

FIG. 11 is a partial perspective view of the wheel racks and forward end of the dump box of the truck of FIGS. 1-10. As shown here, the first and second wheel racks 60A and 60B are part of a frame that is attached to the bed bottom 58. It is a simple matter to orient and attach the racks 60A and 60B in order to provide the necessary alignment and support for the box 16. The wheels 62A and 62B can be positioned differently than shown here depending on the particular vehicle within which the system 10 is being installed.

Those skilled in the art will appreciate that various adaptations and modifications of the just-described preferred embodiment can be configured without departing from the scope and spirit of the invention. Therefore, it is to be understood that, within the scope of the appended claims, the invention may be practiced other than as specifically described herein.

What is claimed is:

1. A dump box system for a conventional pickup truck bed, the bed defining a bottom, a rear opening, and an internal width, the system comprising:
a box defining a width less than said bed internal width rollably resting on said bed bottom;
a hoist system interconnecting said box and said pickup truck, said hoist system configured to lift and lower one end of said box.

2. The system of claim 1, wherein said hoist system further comprises one or more reels, each said reel having a strap element extendable therefrom, each said strap element attachable to a front end of said box.

3. The system of claim 2, wherein said reels rotate around a drive shaft in response to rotation of a drive reel associated with said drive shaft.

4. The system of claim 3, wherein said hoist system is further defined by a crank handle associated with said drive reel, whereby operation of said crank wheel causes said reels to rotate.

5. The system of claim 4, further comprising a plurality of wheels dispersed between said box and said bed, said wheels oriented to allow said box to roll out through said rear opening.

6. The system of claim 5, wherein:
said box is defined by an open rear end; and
said track further has a box gate associated therewith to operably cover or open said open rear end of said box when said box is positioned within said bed.

7. The system of claim 6, wherein said hoist system comprises:
a pair of support posts in spaced relation, said support posts extending upwardly from said truck bed; and whereby
said drive shaft extends between said support posts.

8. The system of claim 7, wherein said support posts extend upwardly from said truck bed on a right and left side defined by said bed, at a position along the length defined by said bed that is between a front end of said bed and a middle section of said bed.

9. The system of claim 8, wherein said support posts extend upwardly from a position that is approximately one-third of the distance between the front end of said bed and the rear end defined by said bed.

10. The system of claim 9, wherein said plurality of wheels extend upwardly from at least one wheel rack attached to said bed bottom.

11. The system of claim 10, wherein said box is defined by a bottom wall having a bottom surface, said bottom surface defined by a rail set located on said bottom surface to cooperate with said wheels of each said wheel rack.

12. The system of claim 11, wherein each said wheel rack comprises at least one wheel directly adjacent to said open end of said bed to support said box to tilt and rest between said open end of said bend and an external surface upon which said truck is resting.

13. A dumpable box system for attachment to a truck, comprising:
a box configured to cooperate with said truck to rollably rest on said truck;
a hoist system interconnecting said truck, said hoist system configured to lift and lower one end of said box.

14. The system of claim 13, wherein said hoist system further comprises one or more reels, each said reel having a strap element extendable therefrom, each said strap element attachable to a front end of said box.

15. The system of claim 14, wherein said reels rotate around a drive shaft in response to rotation of a drive reel associated with said drive shaft.

16. The system of claim 15, wherein said hoist system comprises:
a pair of support posts in spaced relation, said support posts extending upwardly from said truck bed; and whereby
said drive shaft extends between said support posts.

17. The system of claim 16, wherein said hoist system is further defined by a crank handle associated with said drive reel, whereby operation of said crank wheel causes said reels to rotate.

18. The system of claim 17, further comprising a plurality of wheels dispersed between said box and said truck, said wheels oriented to allow said box to roll out through a rear end of said truck.

19. The system of claim 18, wherein:
said box is defined by an open rear end; and
said truck further has a box gate hingeably attached to said truck to operably cover or open said open rear end of said rollable box.

20. The system of claim 19, wherein said support posts extend upwardly from said truck on a right and left side defined by said truck, at a position along the length defined by the truck said that is between a front end of said tuck and a middle section of said truck.
